(19) United States
(12) Patent Application Publication
(10) Pub. No.: US 2010/0145927 A1
(43) Pub. Date: Jun. 10, 2010

(54) METHOD AND SYSTEM FOR ENHANCING THE RELEVANCE AND USEFULNESS OF SEARCH RESULTS, SUCH AS THOSE OF WEB SEARCHES, THROUGH THE APPLICATION OF USER'S JUDGMENT

(76) Inventors: Kiron Kasbekar, Maharashtra (IN); Chirag Kasbekar, Maharashtra (IN); Ghulam Mustafa, Maharashtra (IN)

Correspondence Address: LADAS & PARRY LLP, 224 SOUTH MICHIGAN AVENUE, SUITE 1600, CHICAGO, IL, 60604, US

(21) Appl. No.: 12/520,585

(22) PCT Filed: Jan. 9, 2008
(86) PCT No.: PCT/IN08/00010

§ 371 Date: Feb. 10, 2010

(30) Foreign Application Priority Data
Jan. 11, 2007 (IN) 55/MUM/2007

(51) Int. Cl. G06F 17/30

(52) U.S. Cl. 707/710; 707/E17.108

(57) ABSTRACT

A method and system for enhancing the relevance and usefulness of information searches, such as web searches, by introducing individual and shared user's judgment; first, to define the universe of the search, automatically internalizing the content of that universe (via a copyright-compliant system) in an automatically updated repository that can integrate other (internally generated or imported) content and enable sharing according to user preferences; and, secondly, to organize the internalized content through tagging, book marking and filtering.

### FIELD OF INVENTION

The present invention relates to search engines and more particularly to a method and system that allows users to extract relevant and enhanced search results by making use of their own judgment.

### DESCRIPTION OF THE BACKGROUND ART

An unprecedented volume of business information is available today on the Internet, and the volume is growing every day. Web search engines have made it possible for users to search through very, very large volumes of information, and this has opened up fantastic opportunities for people seeking information from known and unknown sources across the world. However, web search engines have their limitations.

Web search engines offer the advantage that the wider they search the greater the chance that they will throw up information from a website they did not know existed, or had forgotten about. The drawback is that the wider they search, the greater is the proportion of irrelevant links that are thrown up by the search results.

For certain purposes—for example, when a user is looking for something and he/she doesn't know where to look—such wide-ranging searches are useful. However, where the user knows broadly where to look, such wide-ranging search becomes overkill, causing people to waste time wading through a mix of and mostly irrelevant web content.

Research has shown that companies are losing millions of dollars every week or month or year (depending on their size) as a result of their employees wasting hours of time searching for business information on the Internet, half the time not finding it and not being able to locate content previously downloaded from the Internet.

Despite the vast amount of readily available information on the ‘free’ Internet, employees are spending an inordinate and unproductive amount of time searching the Internet for answers to everyday business challenges; a considerable part of which time could be better spent making smarter, faster business decisions or in attending to customer-facing tasks, for example.

In its 2004 report on taxonomy and enterprise search issues, “Information Intelligence: Content Classification and the Enterprise Taxonomy Practice”, Delphi Research addresses the question of the time professionals spend in computer-based search, and how they feel about it. According to a Delphi Group summary of this report, “The results of a new survey of over 300 companies shows that a surprising number of people spend at least the equivalent of a full work day per week trying to find electronic information.

“For example, 30% reported spending more than 8 hours per week in search activities, or more than a full day per week. Over 40% reported spending 7 or more hours. Another 30% reported spending between 4 and 8 hours, or over half a day. These findings indicate once again that the delivered search experience for most professionals is still a long way from the visions of sub-second relevance and enhanced productivity, which often galvanize new search technology investments.

“This finding appears to drive respondents' level of satisfaction with their search experience as expressed in the survey. Over 60% say they are dissatisfied or very dissatisfied with their search experience.” http://www.delphiweb.com/knowledgebase/newsflash guest.htm?nid=953

Matters have got worse since 2004. According to the Outsell Information Industry Outlook 2006, the time users spend searching for (but not necessarily finding) business information on the Internet has risen by three hours per week over the past four years; employees now spend more time finding information than applying it. That's an aggregate productivity drain on U.S. employees of more than 5.4 billion hours wasted in 2005.

Search engines are free, but employee time is not. According to the Society of Competitive Intelligence, the average senior analyst salary is about $70,000 per year. If this analyst spends 11 hours per week searching for information, that's an investment of roughly $500 per week, $2,000 per month, or $24,000 per year, not including overhead and lost opportunity costs.

There is another problem. Here is what Bill Gates, chairman of Microsoft, had to say (at a Microsoft meeting on 17 May 2006) about what he calls information “under-load”: “We're flooded with information, but that doesn't mean we have tools that let us use the information effectively.” Inordinate amount of time wasted by otherwise busy users either on manual housekeeping of the content (if they have worked out some sort of system for doing this) or (in its absence) on revisiting the World Wide Web repeatedly for the same content because they are unable to figure out where they had saved it the first time. This has added to the serious problem of information overload, and has made it harder for enterprise users to manage information, share it with others and add value to it. As Gates puts it, “Companies pay a high price for information overload and under-load. Estimates are that information workers spend as much as 30 percent of their time searching for information, at a cost of $18,000 each year per employee in lost productivity. Meanwhile, the University of California, Berkeley predicts that the volume of digital data we store will nearly double in the next two years.”

There have been other attempts in the past to address these problems; but they have not solved them. For example, enterprise searches allow some level of integration, but when it comes to the web, they function just as regular web search engines do. Other solutions make use of concepts such as clustering to progressively narrow the search within a given set of search results. While these do provide a means to reduce the levels of irrelevance in the search results, they deal with only a small part of the problem. Other methods, such as ‘federated searches’ (which use more than one search engine at the same time to provide combined results from such search engines), actually compound the problem rather than solve it.

‘Web crawlers’, some of which do enable downloads, do not refine the organization and management of the downloaded content, let alone integrating it with content created internally or imported through other means.

Given the serious levels of information overload and under-load suffered by business, academic and government users, there is need for a system and a method that will help organizations reduce their dependence on web search engines.

### SUMMARY

The present invention is based on the assumption that searching through a narrower universe defined by users can enhance the relevance of search results manifold compared with massively wide-ranging online searches done by conventional search engines.

The present invention assures users that they will be updated about the latest information on all the sources in which they are interested, regardless of how busy they are with other work or whether they are in the office or on a business trip or vacation, and that they will automatically get a list of the latest additions to their desired websites without spending even a minute on visiting the Web (other than visiting any online service provided through the use of the present invention).

Accordingly, embodiments of the present invention described herein relate to a method and system that allows users to extract relevant and enhanced search results by making use of their own judgment.

In one embodiment herein, a database of sources of information may be created on a server. A plurality of users may be allowed to create source profiles of selected sources by identifying specific portions of content of the selected sources, specifying the specific portions of the content to be extracted and organizing the sources using labels. Each user may also be enabled to create their own user profiles by assigning desired sources to the user, and tagging a plurality of attributes to the desired sources of information.

A web-crawler may be provided for searching through the selected and desired sources in order to identify and extract fresh content from the selected and desired sources. The web crawler may use the source profiles and the user profiles for performing its search. The extracted content may then be stored in an automatically updatable central repository on the server. A filter module may be provided for filtering the updated contents of the central repository according to a plurality of predefined search parameters. The filtered content may thereafter be displayed to the user on a user device.

An administrator amongst the users may be allowed to tag content of the central repository through a hierarchical central labeling scheme whereas users other than the administrator may be allowed to tag the content with personal labels that can be later modified at will.

In various embodiments herein, users may be provided with an ability to combine the content of the central repository with other content either created by the user or imported from a directory of internally generated and other content, including previously and currently imported documents.

In various embodiments herein, users may also be provided with an ability to combine the repository content with an output of communication events including annotation, comments forwarded with documents, forums, chats, conferences and notes.

In various embodiments herein, users may be provided with the ability to share the combined content and the labels used to organize it with other users in particular communities of practice using a role- or hierarchy-based user management system.

In various embodiments herein, users may be provided with a facility to search through the combined and organized content making use of a multiplicity of search and query parameters to widen or narrow the search in order to enhance the relevance of the results.

In one embodiment herein, a plurality of distributed user devices may be provided for enabling the users to create said source profiles of selected sources, specify the specific portions of the content to be extracted and to create said user profiles. The search results may be displayed to the user on the user devices. The search results may include the filtered contents that may be delivered to the users on their respective user devices.

Other objects, features and advantages of the invention will be apparent from the drawings, and from the detailed description that follows below.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an overview of the application of user's judgment in defining sources and the subsequent crawling of the sources to extract content into a repository in a user-defined way.

FIG. 2 is an overview of the internal processing used to apply user's judgment and enhance value after web content has been downloaded.

FIG. 3 is an illustration of the various processes used to apply individual and shared user's judgment.

FIG. 4 is an illustration of the process of defining the search universe by choosing the sources.

FIG. 5 is an illustration of the process of defining or profiling a source.

FIG. 6 is an illustration of the process of defining or profiling a section of the source.

FIG. 7 is an illustration of the process of internalizing the user-defined content from external sources.

FIG. 8 is an illustration of the process of displaying the internalized content via a copyrighted-content filter.

FIG. 9 is a screenshot illustrating display of the internalized content in a user-defined manner along with a display of associated content.

FIG. 10 is a screenshot illustrating the process of attaching centralized labels to the external content.

FIG. 11 is a screenshot illustrating the process of attaching personal labels to the external content.

FIG. 12 is a screenshot illustrating the process of attaching bookmarks to the external content.

FIG. 13 is a screenshot illustrating the viewing of a list of documents that have a particular label attached to it.

FIG. 14 is a screenshot illustrating the first part of the process of associating other content with the external content.

FIG. 15 is a screenshot illustrating the second part of the process of associating other content with the external content.

FIG. 16 is a screenshot illustrating the process of forwarding annotated documents to other users (or persons outside the system).

FIG. 17 is a screenshot illustrating real-time conferences related to a particular item of content.

FIG. 18 is a screenshot illustrating the process of finally searching through the combined and organized content.

FIG. 19 is a screenshot illustrating the display of updates to the content through a personal dashboard.

FIG. 20 is a screenshot illustrating the process by which users can incorporate documents found through conventional web searches into the system.

FIG. 21 is an illustration of the process by which the system can be implemented on the users' (both individuals and organizations) own computers.

### DETAILED DESCRIPTION OF PREFERRED EMBODIMENTS

Described herein are the various embodiments of the present invention henceforth called “Informachine”, which includes a method and a system that enhances the relevance and usefulness of web information searches through the introduction of user's judgment.

### 1. Overview

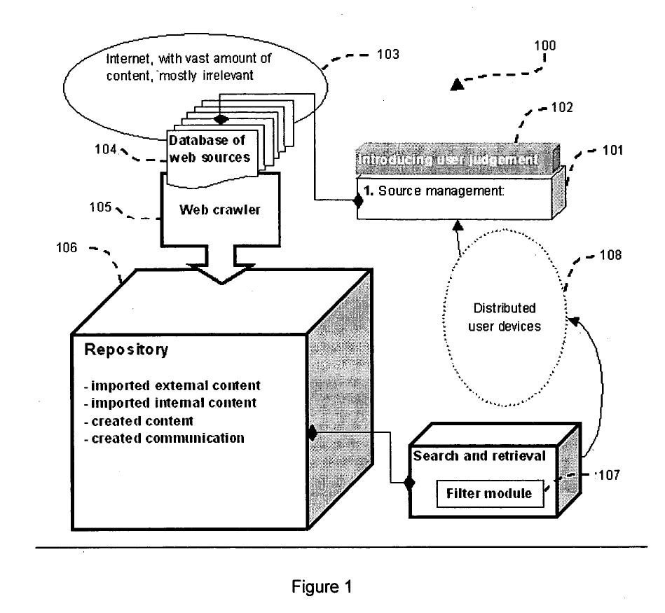

FIG. 1 gives a bird's eye-view of the process by which user's judgment 102 is introduced at the first stage of choosing, defining and downloading content from the sources to include in the search universe.

In one embodiment herein, the system (Informachine) 100 comprises a database 104 of sources of information that may be created on a server (not shown). The sources of information may be obtained from the Internet 103. A plurality of distributed user devices 108 may be configured for allowing the users to create source profiles and user profiles. In one embodiment herein, the source profile may be created by identifying specific portions of content of selected sources, specifying the specific portions of the content to be extracted and organizing the sources using labels. Each user may create their own user profiles by assigning desired sources to themselves, and tagging a plurality of attributes to the desired sources of information.

A web-crawler 105 may be provided for searching through the selected and the desired sources in order to identify and extract fresh content from the selected and the desired sources. The web crawler 105 may use the source profiles and the user profiles for performing its search. The extracted content may then be stored in an automatically updatable central repository 106 on the server. A filter module 107 may be provided for filtering the updated contents of the central repository 106 according to a plurality of predefined search parameters. The filtered content may thereafter be displayed to the user on a user device 108.

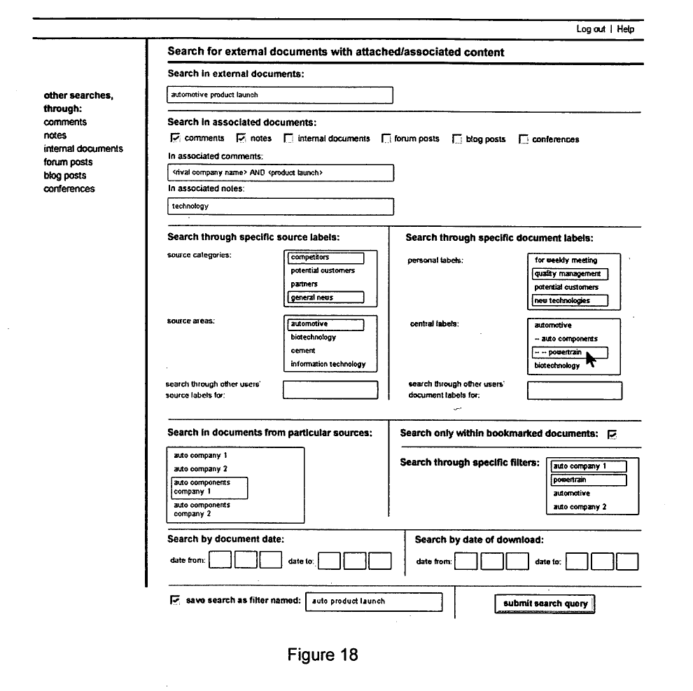

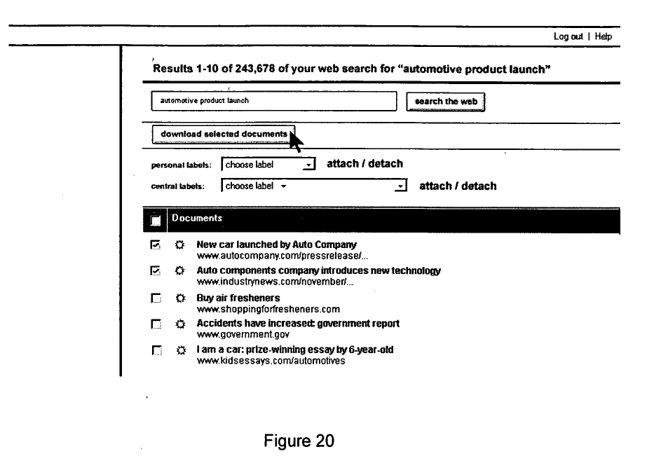

Informachine allows users to define all the sources (such as company websites) they believe will offer them content relevant to their interests and adding them to a database 104 of web sources after tagging them with descriptors. It also allows users to define which portions (such as the titles, dates and main text of pages in the press release section) of the sources they will find most relevant. Then the Informachine web crawler 105 will use the source profiles created by the users to visit the web sources, look for fresh content of the type described by the user, download the content as described by the user into the Informachine content repository 106 (which comprises a database and a file storage server), which also contains content imported from users' own devices 108 and content created during the internal processing of the Informachine 100. Informachine also allows (as shown in FIG. 20), the importing of external documents found through conventional web search engines into the system for the purpose of storing, organizing, combining with other content, sharing and searching through. This content can be searched and sorted as shown in FIG. 18, with facilities to allow the user to make use of the descriptors attached to the sources in the search.

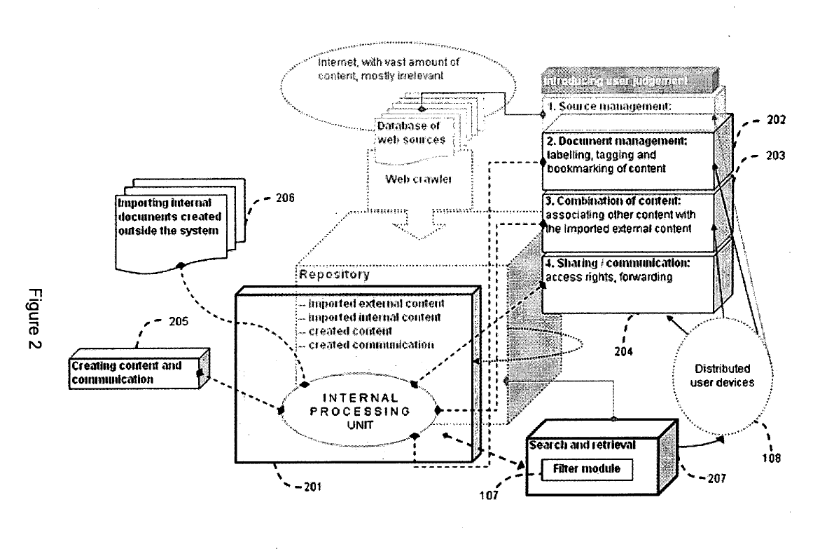

FIG. 2 is an overview of the internal processing used to apply user's judgment and enhance value after web content has been downloaded and stored in a repository for search and retrieval at the user's convenience.

To allow the application of user's judgment to the content in the repository and to make it more useful, Informachine introduces an internal processing unit 201, which is an assemblage of processes. The internal processing unit 201 includes a content creating and communication module 205 for allowing the users to create communicable content such as comments, notes, blog posts, forum posts and conference chats and associate them with the external content so as to discuss and analyze it.

The internal processing unit 201 also includes an import module 206 for importing internal documents created outside the system 100 (of FIG. 1). Users can import content from their own devices 108 into Informachine 100 (of FIG. 1).

User's judgment can be applied at this stage in three ways:
through a document management system 202 that allows the labeling/tagging, and book marking of the repository content
through the combination or association 203 of different types of other content (such as that created with the content creation and communication module 205, which is a part of the internal processing unit 205, and the content imported from the users' own computers) with the content downloaded from external sources, a process which acts in a way similar to tagging.
through the sharing 204 of (combinations of) content and the labels used to organize it within an organization or community with a view to benefiting from other users' judgment and experience

After the external (web) content has been downloaded, extracted, organized, combined with other content and shared within the organization or community, a search and retrieval tool 207 may be provided to exploit all the user's judgment applied to the web content to search through the content and find more relevant information.

The filter module 107 (of FIG. 1) may be provided within the search and retrieval tool 207 as shown. Various other plugged-in tools such as currency and other converters, diaries, planners, etcetera may also be provided along with the search and retrieval tool 207.

### 2. Introducing User's Judgment to Define the Search Universe

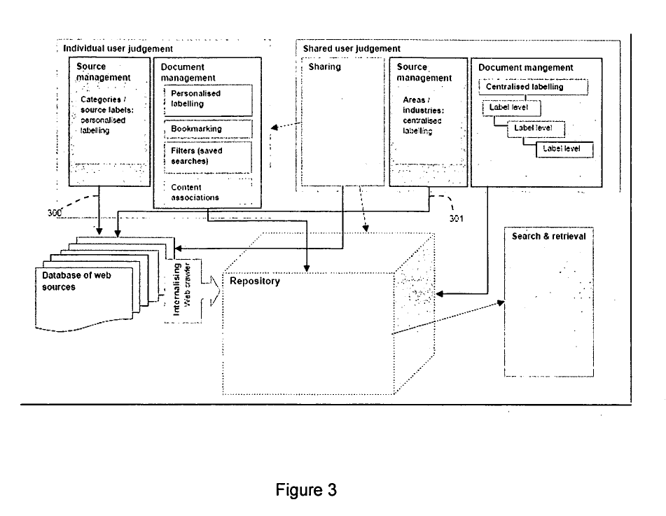

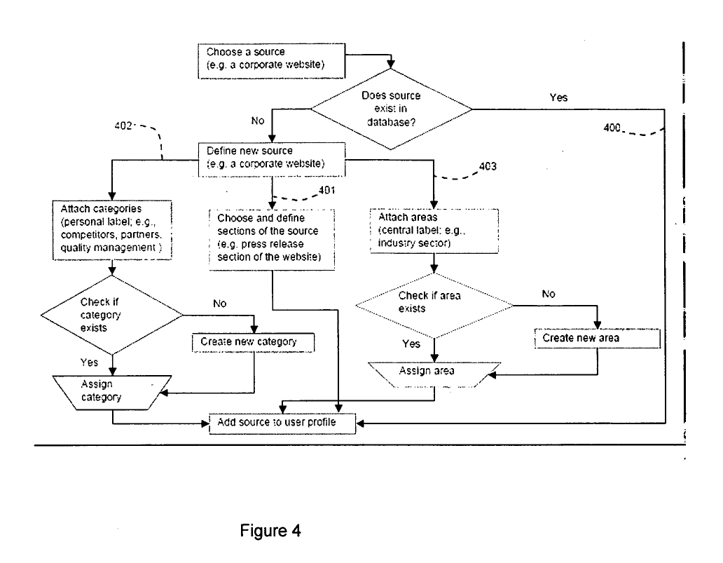

FIG. 3 is an illustration of the various processes used to apply individual and shared user's judgment and FIG. 4 is an illustration of the process of defining the search universe by choosing the sources.

Informachine enables organizations and individual users to use their knowledge and judgment to choose, and add to a database, all the sources, such as websites, from which they are likely to find content of relevance to their needs and, therefore, from which they would like the system to regularly download fresh content so that it can be managed and searched when they require to.

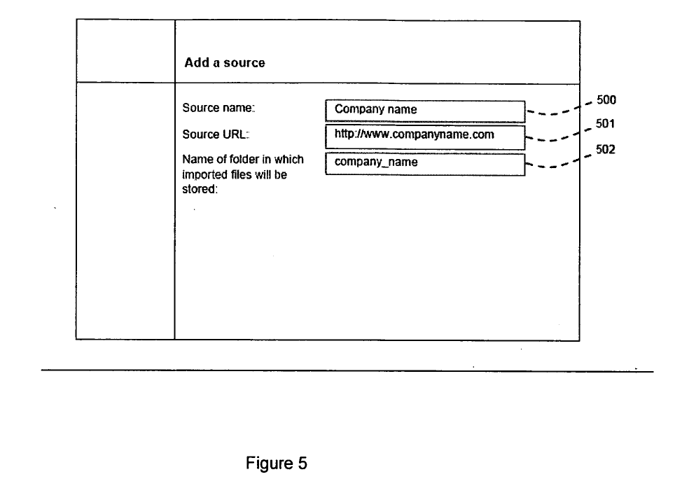

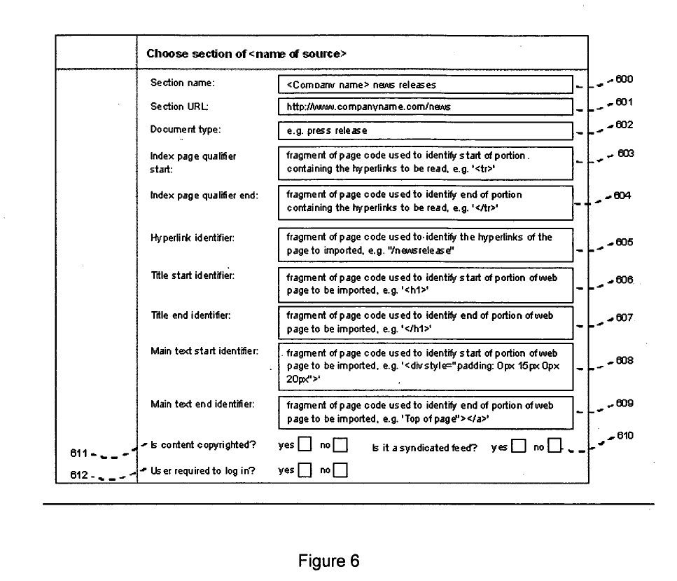

The source management process 101 (of FIG. 1) allows the user to create source of each source by:
identifying the sections of the source that need to be profiled, identifying portions of the pages of that section, such as the title and main content, to be extracted, as shown as process 401 in FIG. 4 and in FIG. 5 and FIG. 6.
assigning attributes to these sources through different styles of tagging as illustrated by processes 300 and 301 in FIG. 3, and processes 402 and 403 in FIG. 4.

As illustrated in FIG. 4, when a user chooses a particular source, the internal processing unit 201 (of FIG. 2) checks whether the source already exists in the database 104 (of FIG. 1). If it exists, then the source is added to the user's profile (process 400). If it is not in the database, then the user or a knowledge officer/librarian is given the facility to add the source to the database by profiling it in a manner as described by FIGS. 4-6 and assigning two types of tags/labels to it: source categories, which are personalized labels specific to an individual user, and source areas, which are centrally administered source labels common to all users in a community. The source areas may be administered by an administrator such as a knowledge officer or a librarian.

FIG. 5 is an illustration of the process of defining or profiling a source and gives an example of the kind of information that might be entered while adding and profiling a new source such as a corporate website: the company's name 500, the company's website address or universal resource locator (URL) 501, and the name of the folder in the repository (web server or a computer on the local network) in which the files (such as images or .doc, .xls, .ppt or .pdf documents) downloaded from the website will be stored 502.

FIG. 6 is an illustration of the process of defining or profiling a section of the source. It gives an example of the kind of information that might be entered in profiling a new section of a chosen source (such as the ‘news release’ or ‘white papers’ sections of a corporate website): the name of the section 600, for example, “ABC company news releases”; the web address or URL of the section 601, e.g. http://www.ABCcompany.com/news; the type of document content downloaded from the section will be 602, e.g. press release or white paper; the index page qualifier start 603, which would be a fragment of HTML that the system will use to identify the beginning of the portion of the section index page that contains all the hyperlinks that need to be read and visited; the index page qualifier end 604, which would be a fragment of HTML that the system will use to identify the end of the portion of the section index page that contains all the hyperlinks that need to be read and visited; the hyperlink identifier 605, which identifies which hyperlinks on the section web page the system's web crawler should visit to download content, which could be a fragment of HTML code of the web page, for example, a part of the full path of that type of hyperlink that will present in all hyperlinks of that type (“/newsrelease” from “http://www.ABCcompany.com/news/newsrelease/filename.html”); the title start identifier 606, which identifies the start of the title of the content to be downloaded once the link has been identified and visited and could again be a fragment of HTML code that is always present in that type of page and can always be relied on to identify the start of the title; the title end identifier 607, a fragment of HTML code which can be used to identify the end of the title of the content to be downloaded; the main text start identifier 608, a fragment of HTML code which can be used to identify the start of the main text to be downloaded; the main text end identifier 609, a fragment of HTML code which can be used to identify the end of the main text of the content to be downloaded.

In a similar manner, other identifiers can be included if other portions of content from the web page, such as the published date of the content, have to be downloaded.

Information will also need to be added about whether the source content is copyright-protected or not 610; whether the content requires subscription or registration and the user has to log in using a user name and password 611; and also the nature of the content: whether it is an ordinary web page or a syndicated feed 612, for instance.

### 3. Crawling Through the Defined Sources to Extract Fresh Content

Once these profiles have been added to the database, the web crawler uses the identifiers entered to first identify freshly added web pages through the new hyperlinks it notices on the on the section page and, visits those fresh pages on a regular, cyclical basis to identify and download the user-desired portions of the pages by making use of the identifiers entered.

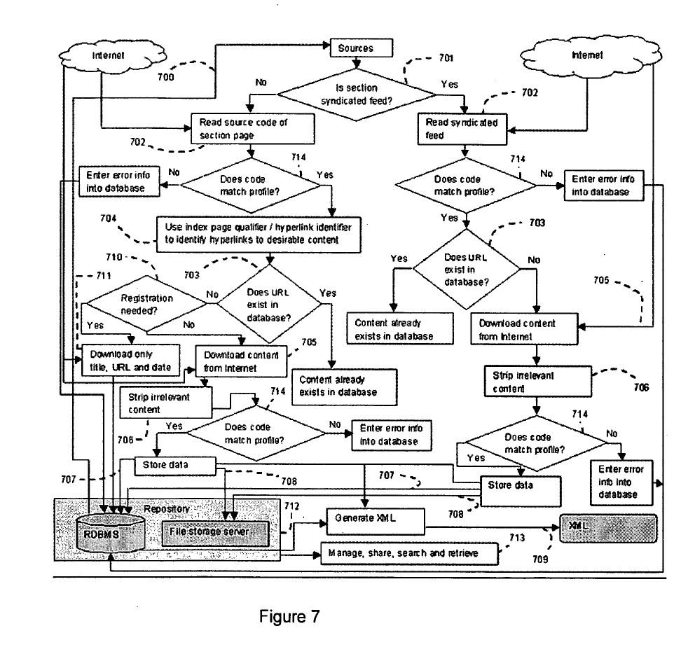

FIG. 7 is an illustration of the process of internalizing the user-defined content from external sources. It describes the process followed by the web crawler once the sources have been added into the database.

The web crawler 105 (of FIG. 1) obtains 700 source profiles from the database104 and checks 701 if the content of the section is a syndicated feed or an ordinary web page. If the content is a syndicated feed, the crawler reads 702 the syndicated feed and checks 703 if the URLs or web addresses listed in the feed are already in the web source database. If they are not present in the database, the web addresses are visited and the content found is downloaded 705. If the syndicated content is a web page, identifiers 606-609 (of FIG. 6) are used to identify the portions to be extracted from it and the rest of the web page is stripped 706 so that the extracted content can be stored 707 in the Informachine database. If the content found at the web address is a file other than an .html file (e.g. a .pdf, .doc, .ppt, .gif, .jpg or .xls file), it is downloaded 708 into the folder specified 502 in the section profile (refer FIG. 5).

If the content is not a syndicated feed, the crawler visits the section of the source specified by using the URL provided 601 in the section profile and, in the page code, uses the hyperlink identifier 605 to identify 704 hyperlinks of the type that the user desires and checks 703 if each URL identified in this way is present in the database or not. If a URL doesn't exist in the database, the system first checks 710 if the content requires subscription or registration and the user to log in (as specified in the source section profile 609). If it does, the full content is not downloaded into the repository. Instead only the titles, web addresses and publishing dates of the content (as defined by the user in the source profile) are downloaded into the database 711, so that the user can go to the original web page to enter subscription or registration details before downloading the full content for personal use. If it does not require the user to log in, the source section is visited and the content found is downloaded 705. If the content is a web page, identifiers 606-609 are used to identify the portions to be extracted from it and the rest of the web page is stripped 706 so that the extracted content can be stored 707 in the Informachine database. If the content found at a web address is a file other than an .html file (e.g. a .pdf, .doc, .ppt, .gif, .jpg or .xls file), it is downloaded 708 into the folder specified 502 in the section profile (refer FIG. 5).

The date of the download is recorded.

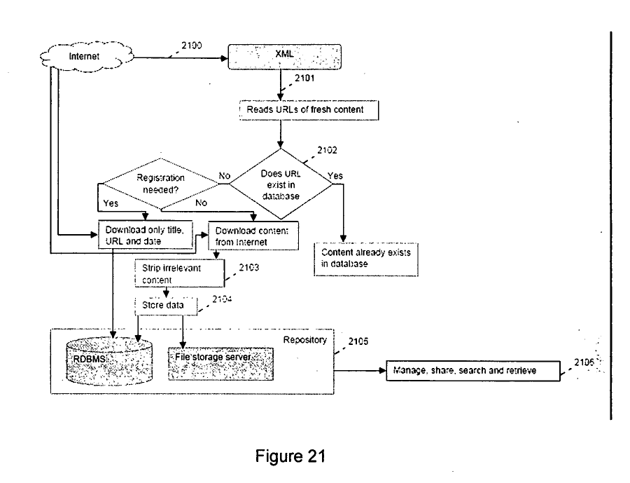

When all content downloads for a particular cycle are complete, the web crawler generates 709 an XML (it could be any other similar type of extensible marked-up format) file residing on the web server and containing profile information, such as URL, title, date, description, about the freshly downloaded content. This will allow embodiments of Informachine that have the application installed on a company's local network (see FIG. 21) to independently download content using the profiles stored in XML form. This process (as described by FIG. 21), by which each independent individual or organization using Informachine is forced to download content afresh from copyright-protected websites, helps to ensure that laws that prevent the unauthorized distribution of copyrighted content are not flouted.

Each cycle of the web crawler also includes processes for tracking the process for errors 714 arising out of a mismatch between the identifiers used to identify portions of a source, such as a web page, and the structure of the content (if and when such structure is modified by the owner of the source website), and notifying the system of the errors.

### 4. Displaying the Extracted Content in a User-Defined Format

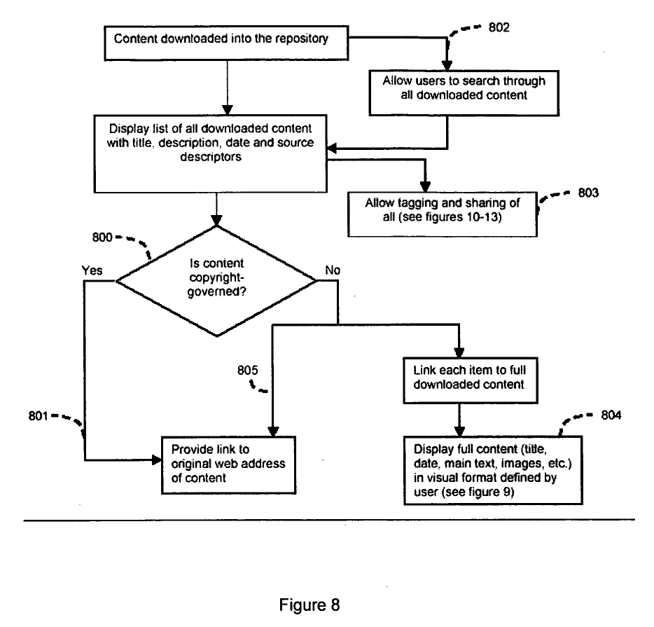

FIG. 8 is an illustration of the process of displaying the internalized content via a copyrighted-content filter.

Once the content is downloaded, as described in FIG. 8 the system checks 800 in the profile if the use and distribution of source content is restricted by copyright protection. If it is, then the copyright-protected portions (the main text) of the content downloaded are not displayed to the user. The user is instead shown 801 only the titles and short descriptions of the content and when the user clicks on the title of the downloaded content, he/she is taken directly to original version of the web page on the source website.

If the content requires subscription or registration, again, only the titles, web addresses and publishing dates of the content (as defined by the user in the source profile) are displayed, so that the user can go to the original web page to enter subscription or registration details before viewing the content in its original form on the Internet. Once the user has entered the subscription details, she/he can download the content for personal use by clicking on the ‘download this item’ button on the display page of such content. The system will check if the user has entered subscription information or not before downloading it.

The content extracted and downloaded from copyright-protected sources and stored in the Informachine database (or external content) can be used by the user for search 802 and management 803 purposes, but cannot be viewed.

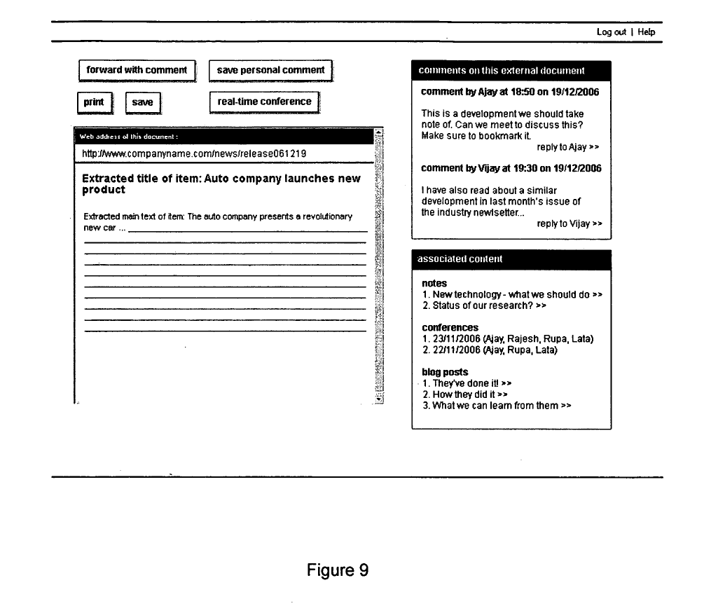

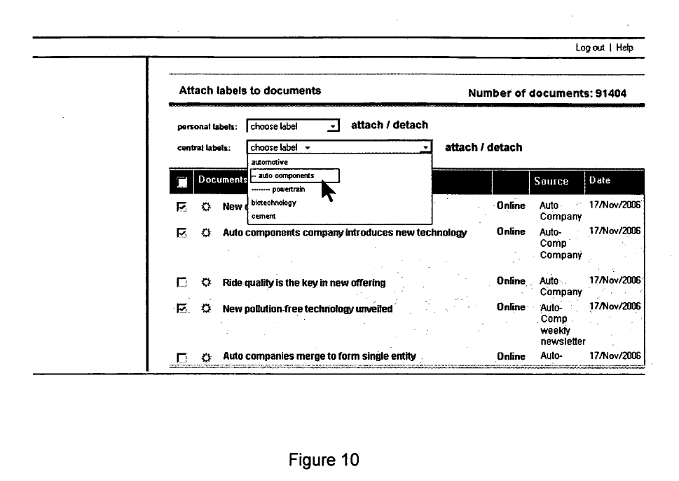

If the content is not copyright-protected (as in the case of company press releases), the content extracted and stored in the Informachine database is displayed 804 in a visual display designed to suit the user's tastes and Usability preferences as shown in FIGS. 9-10.

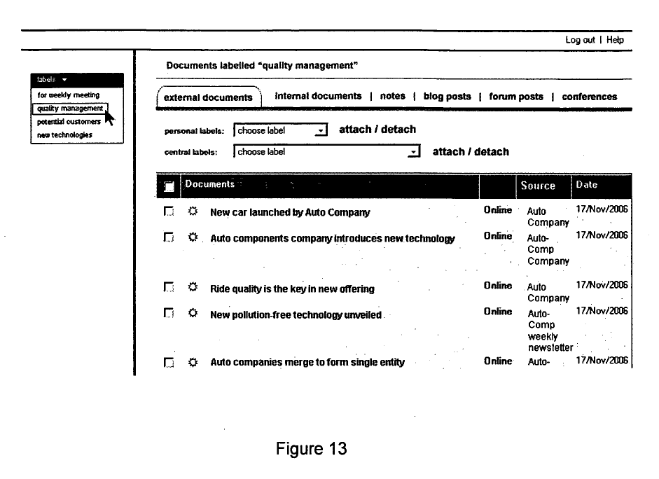

FIG. 9 to FIG. 20 show various screen shots that may be displayed on the user devices as per various embodiments of the present invention.

FIG. 9 is a screenshot illustrating a display of the internalized content in a user-defined manner along with a display of associated content.

FIG. 10 is a screenshot illustrating the process of attaching centralized labels to the external content.

The user can view the content on their devices without having to visit the source website on the Internet. The content can be displayed through a browser on the user's computer, or, if the user desires it, on other devices and applications capable of reading the content, such as the user's PDA or mobile phone. The viewer can also view the original version of the content on the source website through the Internet if he/she chooses.

### 5. Introducing User's Judgment to Organize the Extracted Content

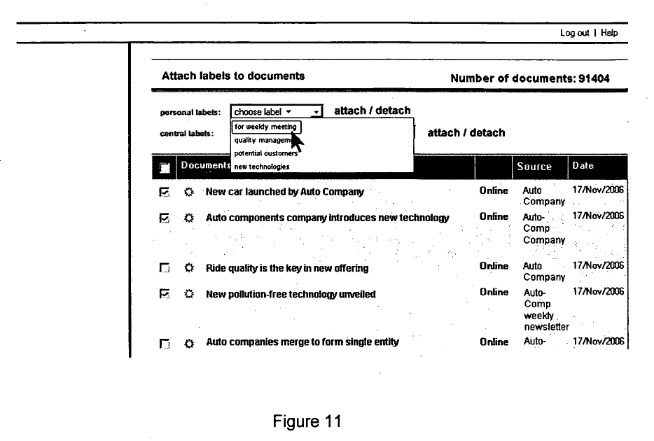

Whether the content is copyright-protected or not, Informachine allows users to organize it once it has been downloaded. The application of individual user's judgment through personalized labeling or tagging and book marking (both of which can be managed by the individual user himself/herself) as shown in FIG. 11 to FIG. 13, can be shared through searches such as the type shown in FIG. 18.

The application of shared judgment through hierarchical centralized labeling that allows an organization or community (through perhaps a knowledge officer or librarian) to apply a set of labels (managed collectively), as shown in FIG. 10, to the content that will be common to all users in the community.

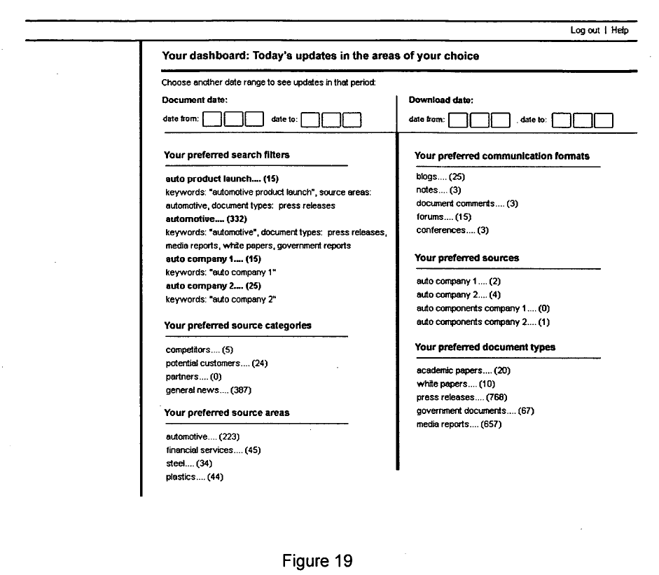

The automatic filtering of freshly downloaded content using a pre-defined keyword search as shown in FIGS. 18 and 19 (see “Your preferred search filters” in FIG. 19) so that content is automatically organized by keyword, or by a (user-defined) combination of keywords and several other descriptors, such as source, source area and category, and users are alerted whenever there is fresh content that contains particular keywords and are from particular sources or source types.

Both types of labeling—personalized and centralized—can be managed by adding, deleting or renaming labels. In the case of centralized labeling, the labels may be arranged in a hierarchical manner and may be managed centrally by users such as an administrator, a knowledge officer or librarian who is authorized to do so.

FIG. 10 illustrates the process by which the user can apply a ‘central label’. First the user selects the documents to be labeled by clicking on a checkbox next to them. Then the user chooses the label he/she wants to attach to or detach from the document.

A similar process, illustrated by screenshot as shown in FIG. 11, can be used to apply ‘personal labels’.

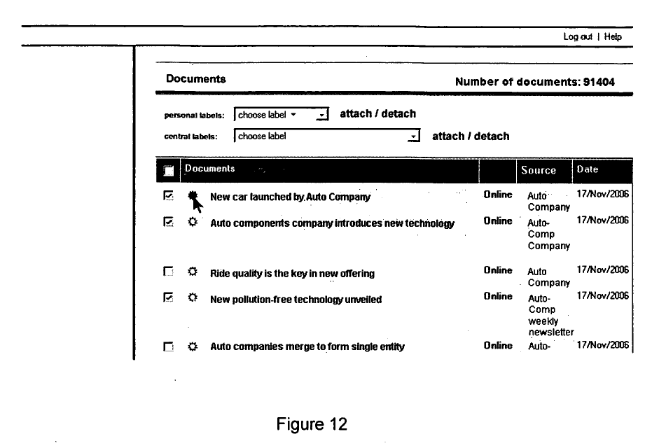

Book marking, as shown by the screenshot in FIG. 12, can be done by first selecting the documents to be bookmarked and then clicking on the toggle bookmark icon.

To save a search as a filter, Informachine allows (see FIG. 18), users to click on ‘Save search as filter named’ as shown to create a new filter that will consist of all the parameters entered in the search that are applicable at the source level.

6. Introducing User's Judgment to Combine the Extracted Content with Other Content and Share and Discuss the Output

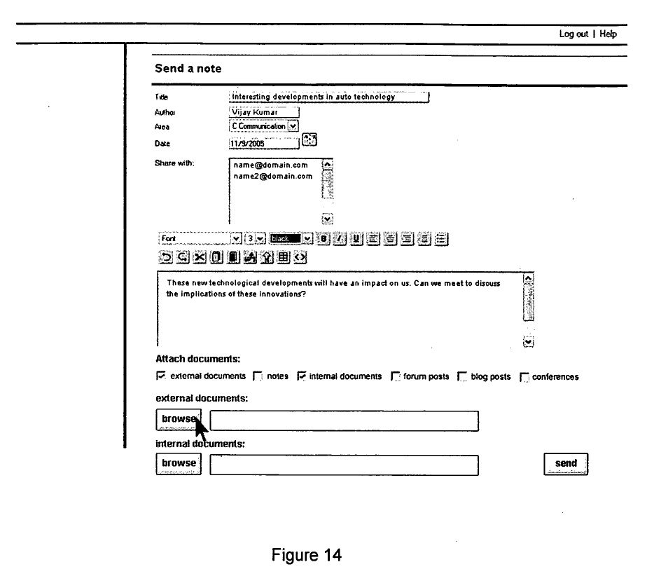

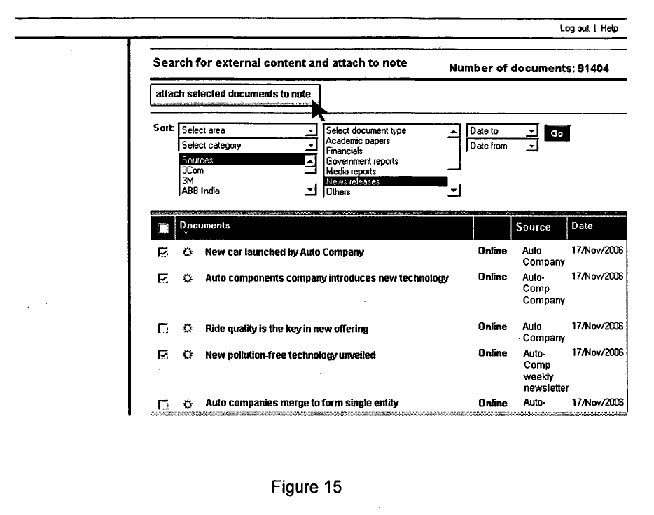

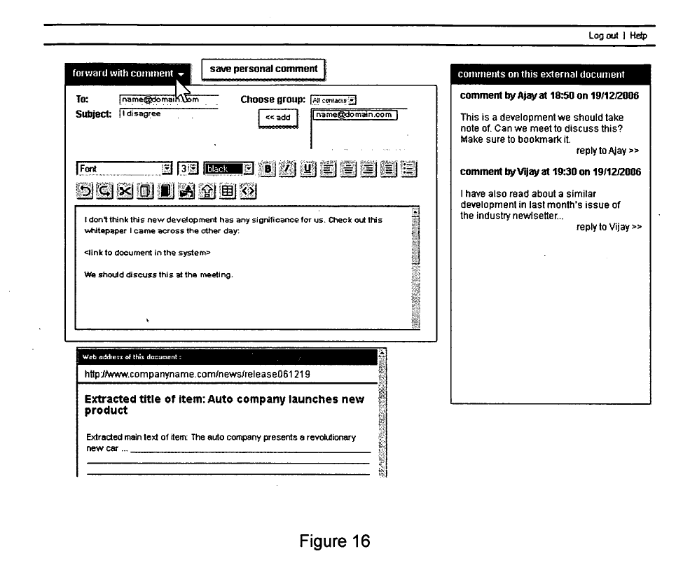

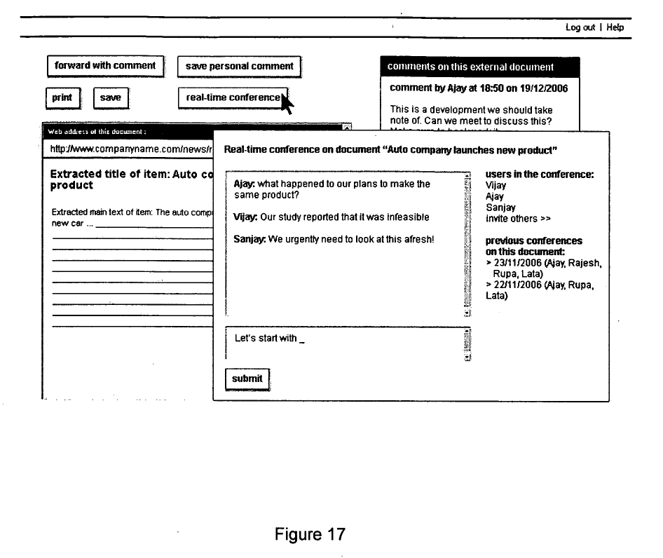

To allow users to add value to the downloaded content and hold discussions around it, Informachine allows the combination of the content with other types of content:
With content created through Informachine's content creation and communication module 205 (of FIG. 2) (e.g., blog posts, discussion forum posts, notes and memos). As shown in FIGS. 14 and 15, after the content to be created has been entered, the user can attach the content downloaded from external sources by clicking on ‘browse’ (see FIG. 14), selecting the documents to be attached after sorting through the documents (see FIG. 15), and clicking on ‘attach selected documents to <name of type of content being created>’ (in FIG. 15, the ‘type of content is a ‘note’). As shown in the screenshot in FIG. 16, the user can also forward the content downloaded to other users with attached comments.
With conference chats: Informachine allows users to discuss particular documents on a real-time basis with other users through document-related conference chats as shown in FIG. 17.
With content imported into Informachine through other means, such as from the user's local computer, Informachine allows a search for content on the user's personal computer or computer network, its incorporation into the system and its association with content downloaded from web sources.

These associations (including the archived conference chats) may be displayed to the user along with the external document itself as shown in FIG. 9.

7. Allowing the Sharing of the Extracted, Organised and Combined Content with Other Users in a Community

The combined content and the labels attached with them can be shared between users in a community. This allows not only the sharing of user's judgment, which would result in easier location of content in a community or organization; it also allows the use and discussion of the web content.

Sharing is done either through direct forwarding as shown in FIG. 16, or by combination with items of communication (notes, forums, blog posts, forum posts, etc.) as shown in FIGS. 14, 15 and 16.

Informachine's user management system controls access rights given to users and only users authorized to see the type of content being forwarded will be able to see it. Informachine's contact management system allows users to manage their contacts list—including organizing them into groups or communities of practice—and users are allowed to share content with others in their contacts list.

Documents forwarded to other users will appear in their ‘inboxes’ and they can click on and read the content and the comments or notes forwarded (or just the comments). Documents can also be forwarded to users' email addresses and mobile phones, especially if the user is not a part of the community or organization.

Informachine allows users to share labels attached to documents by other users in the community by allowing them to search through these labels for keywords, as shown in FIG. 18. This is an important way in which user's judgment can be shared in the system.

### 8. Allowing a Search of the Extracted Content, Making Use of Individual and Shared User's Judgment Used to Organise it

Users can ultimately make use of the user's judgment that has been applied in various ways (as described above) to content from web sources to find information more easily through two ways:
sorting and sifting through content: as shown in FIG. 15, the user can sort through the external content using the tagging done at the source level (source areas, source categories, document types), the date of the download, and the sources themselves, to find the content they are looking for
searching through content in a variety of ways: as FIG. 18 shows, the user can look for a particular document by simultaneously searching for particular keywords in the external content, for particular keywords in associated (attached) documents, for content labeled with particular source and document labels, for particular keywords in other users' source and document labels, for content from particular sources, only within bookmarked content, for content filtered through specific filters, for content downloaded between particular dates (‘download dates’), and for content having particular publishing dates (‘document dates’)

As shown at the bottom of FIG. 18, Informachine allows users to save their searches as filters, so that whenever new content downloaded from external sources fits the saved search parameters the user can be alerted.

9. Alerting Users about New Content that Accords with their Preferences

Through the Informachine dashboard (see FIG. 19), users can see the latest updates in web content (and also internal content) in the areas they are interested in. These alerts are made immediately after the content has been downloaded and extracted and, therefore, they are only organized according to the labels and other descriptors applied at the source level.

The user can choose which search filters, sources, source areas, source categories, document types, central labels, and also communication formats he/she would like dashboard updates in. The user can also choose another set of download and document dates to view the updates that took place in that period.

Users can choose to receive the same updates in the areas of their interest by email or directly to their computers, mobiles or PDAs. The content would either be sent to their computer, PDA or mobile, if the user wishes so, or just a hyperlink would be sent to him/her so that he/she can follow it and, after logging into the Informachine system with a user name and password, view the content within the system.

### 10. Inclusion of Documents Found Through Web Search Engines

Informachine allows users to use a conventional web search (such as Google, Yahoo or MSN) to search the Internet, and then displays the search results in a manner shown in FIG. 20, with checkboxes next to each item to allow users to select the items they find relevant. Once users have selected documents in this way, they can click on ‘download selected documents’, as shown in FIG. 20, and the content is downloaded into the repository to be displayed and managed as shown in FIGS. 9-19. Informachine also allows (as shown in FIG. 20), the importing of external documents found outside of Informachine, through conventional web search engines, into the system for the purpose of storing, organizing, combining with other content, sharing and searching through. This content can be searched and sorted through as shown in FIG. 18, with facilities to allow the user to make use of the descriptors attached to the sources in the search.

To conform to copyright laws, if this content is copyright-protected, it will be visible only to the user who conducted the search. If he/she shares it with other users, they will only be able to see the original online version as in the case of copyright-protected content in general.

### 11. Tools to Further Aid Use of the Content

Informachine offers plugged-in tools such as currency converters, other types of converters and calculators, dictionaries, thesauruses, and diaries and planners for easier analysis and use of the content.

### 12. Variety of Ways of Structuring the System

Making the system available to individuals and organizations (through a multi-level, multi-user, role-based system) on the Web: In this version of Informachine, as shown in FIG. 7, both, the repository of content 712 and the tools 713 to manage, share, search and retrieve the content in the repository reside on the Web and are made available to users, both, independent and within organisations, through a device (such as a desktop or laptop computer or PDA or mobile phone) and application (such as a web browser) with access to the Web and capable of reading the content.

Making the system available to individuals and organizations (through a multi-level, multi-user, role-based system) on their own computers: In this version of Informachine, as shown in FIG. 21, both, the repository of content 2101 and the tools 2102 to manage, share, search and retrieve the content in the repository reside on the individual's computers or the organization's network of computers and are made available to users, both, independent and within organizations, through a device (such as a desktop or laptop computer or PDA or mobile phone) and application (such as a web browser) capable of reading the content.

As shown in FIG. 7, and explained earlier, when all content downloads for a particular cycle are complete, the web crawler generates 708 an XML (or any other similar type of extensible marked-up format) file residing on the web server (containing profile information-such as URL, title, date and description—about the freshly downloaded content). Installations of the Informachine system on the users' own computers or computer network then independently download content into their own repositories using the profiles stored in XML form (see FIG. 21).

First the system installed on the users' computers reads 2100 and 2101 the XML file residing on the web server to pick up profiles of the latest updates. Then it checks 2102 to see if the URL already exists in the database and then follows the same procedure as that followed in the case of the web version to accommodate content that the user to subscribe or register in order to view it (see FIG. 7), before downloading the content, stripping irrelevant elements from that content 2103 and storing it 2104 in the users' repository 2105.

After this the user can use the tools described above (but now residing on the users' machines) to manage, share, search and retrieve the content in the repository 2106. Copyright laws are respected through the same process described in FIG. 8.

This process (as described by FIG. 21), by which each independent individual or organization using Informachine is forced to download content afresh from copyright-protected websites, helps to ensure that laws that prevent the unauthorized distribution of copyrighted content are not flouted through a centralized dissemination of that content.

The foregoing description of the invention has been described for purposes of clarity and understanding. It is not intended to limit the invention to the precise form disclosed. Various modifications may be possible within the scope and equivalence of the appended claims.

1. A method for extracting enhanced search results by making use of a user's judgment, the method comprising the steps of:
creating a database of sources of information on a server;
enabling the user to create source profiles of selected sources by identifying specific portions of content of the selected sources, specifying the specific portions of the content to be extracted and organizing the sources using labels;
enabling the user to create a user profile by assigning desired sources to the user, and tagging a plurality of attributes to the desired sources of information;
crawling through the selected and the desired sources to identify and extract fresh content from the selected and the desired sources by using the source profiles and the user profiles;
storing the extracted content in an automatically updatable central repository on the server;
filtering updated contents of the central repository according to a plurality of predefined search parameters and displaying the filtered contents to the user on a user device;
enabling an administrator amongst the users to tag content of the central repository through a hierarchical central labelling scheme while enabling the individual user to tag the content with personal labels that can be modified at will;
providing the user with the ability to combine the content of the central repository with other content either created by the user or imported from a directory of internally generated, and other including previously and currently imported documents;
providing the user with an ability to combine the repository content with an output of communication events including annotation, comments forwarded with documents, forums, chats, conferences and notes;
providing the user with the ability to share the combined content and the labels used to organize it with other users in particular communities of practice using a role-based user management system;
providing a facility to search through the combined and organized content making use of a multiplicity of search and query parameters to widen or narrow the search in order to enhance the relevance of the results; and
displaying the search results to the user on the user device.

2. The method according to claim 1 wherein the user device includes desktop, laptop, computer, personal device assistant (PDA), mobile phone.

3. The method according to claim 1, wherein the search results are displayed in a format predefined by respective users.

4. The method according to claim 3, wherein the format is predefined according to a device profile of the user device.

5. The method according to claim 3 wherein the format is predefined according to applications of the user device, the applications including web browser with access to the Web and capable of reading the search results.

6. The method according to claim 1, wherein the sources of information includes websites and sections of websites such as web pages.

7. The method according to claim 6, wherein the specific portions includes title, main content and images displayed on web pages.

8. The method according to claim 1, wherein the user is an individual.

9. The method according to claim 1, wherein the user is an organization or units/departments of said organization.

10. The method according to claim 1, further comprising the steps of:
tracking for errors arising out of a mismatch between the identified specific portions of the source, and structures of the content that is modified by the owner of the source; and
notifying the server of the errors.

11. The method according to claim 1, further comprising the steps of:
enabling the users to distinguish between content that can be legally downloaded and distributed, and content which cannot be legally downloaded and distributed without authentic permission or payment; and
displaying each type of content in a manner that complies with intellectual property rights (IPR) requirements.

12. The method according to claim 1, further comprising the steps of:
enabling users to distinguish between content that requires subscription and content that does not require subscription; and
displaying the content that requires subscription only after the user has entered subscription or registration details.

13. The method according to claim 1 further comprising the step of enabling users to create alerts and newsletters for individuals, communities of interest within the organization, or wider groups, and to broadcast these in formats such as desktop alerts, email and mobile messages.

14. The method according to claim 1 further comprising the step of providing plugged-in tools such as a currency converter, a facility to export external content to content management systems so as to be able to create documents (such as HTML, .doc, .xls, .ppt files) from it, diaries and planners to help integrate the content with time-bound processes.

15. A system for extracting enhanced search results, the system comprising:
a server having a database of sources of information content;
a plurality of distributed user devices, each user device enabling a user to create source-profiles of selected sources by identifying specific portions of content of the selected sources and specifying the specific portions of the content to be extracted, and enabling the user to create a user profile by assigning desired sources to the user, and tagging a plurality of attributes to the desired sources of information;
a web-crawler for searching through the selected and the desired sources to identify and extract any fresh content from the selected and the desired web-sources by using the source-profiles and the user profiles;
an updatable central repository located on the server for storing the extracted contents; and
a filter module for filtering updated contents of the central repository according to a plurality of predefined search parameters;
wherein the filtered contents are delivered as search results to the user on the user device.

16. The system according to claim 15, wherein the user device includes desktop, laptop, computer, personal device assistant (PDA), mobile phone.

17. The system according to claim 15, wherein the search results are displayed in a format predefined by respective users.

18. The system according to claim 17, wherein the format is predefined according to a device-profile of the user device.

19. The system according to claim 17, wherein the format is predefined according to applications of the user device, the applications including web browser with access to the Web and capable of reading the search results.

20. The system according to claim 15, wherein the sources of information includes websites and sections of websites such as web pages.

21. The system according to claim 20, wherein the specific portions includes title, main content and images displayed on web pages.

22. The system according to claim 15, wherein the user is an individual.

23. The system according to claim 15, wherein the user is an organization or units/departments of said organization.

24. The system according to claim 15, wherein errors arising out of a mismatch between the identified specific portions of the source, and structures of the content that is modified by the owner of the source are tracked and notified to the server.

25. The system according to claim 15, wherein users are enabled to distinguish between content that can be legally downloaded and distributed, and content which cannot be legally downloaded and distributed without authentic permission or payment and each type of content is displayed in a manner that complies with intellectual property rights (IPR) requirements.

26. The system according to claim 15, wherein the users are enabled to distinguish between content that requires subscription and content that does not require subscription, and the content that requires subscription is displayed only after the user has entered subscription or registration details.

27. The system according to claim 15, wherein the an administrator amongst the users is enabled to tag content of the central repository through a hierarchical central labelling scheme while enabling individual user to tag the content with personal labels that can be modified at will.

28. The system according to claim 15, wherein the user is provided with the ability to combine the content of the central repository with other content created either through the user or content imported from a directory of internally generated and other, including previously and currently imported, documents.

29. The system according to claim 15, wherein the user is provided with an ability to combine the repository content with an output of communication events, including annotation, forwarding of documents with comments, forums, chats, conferences and notes.

30. The system according to claim 28 or 29, wherein the user is provided with an ability to share the combined content and the labels used to organize it with other users in particular communities of practice using a role-based user management system.

31. The system according to claim 30, wherein the user is provided with a facility to search through the combined and organized content making use of a multiplicity of search and query parameters to widen or narrow the search in order to enhance the relevance of the results.

32. The system according to claim 15, wherein the user is provided with a facility to create alerts and newsletters for individuals, communities of interest within the organization, or wider groups, and to broadcast these in formats such as desktop alerts, email and mobile messages.

33. The system according to claim 15, wherein the user is provided with plugged-in tools such as a currency converter, a facility to export external content to content management systems so as to be able to create documents (such as HTML, .doc, .xls, .ppt files) from it, diaries and planners to help integrate the content with time-bound processes.
